(19) United States
(12) Patent Application Publication
(10) Pub. No.: US 2024/0367433 A1
(43) Pub. Date: Nov. 7, 2024

(54) INK DROPLET VOLUME MEASUREMENT APPARATUS, INKJET PRINTING APPARATUS INCLUDING THE SAME, AND INK DROPLET VOLUME MEASUREMENT METHOD

(71) Applicant: Samsung Display Co., LTD., Yongin-si Gyeonggi-do (KR)

(72) Inventors: YU KONTA, Yongin-si (KR); LAEHO KIM, Yongin-si (KR); Jae Bum PAHK, Yongin-si (KR); MINWOO LEE, Yongin-si (KR); HYEONSEON JEONG, Yongin-si (KR); Jai Hyuk CHOI, Yongin-si (KR)

(21) Appl. No.: 18/396,846

(22) Filed: Dec. 27, 2023

(30) Foreign Application Priority Data
May 2, 2023 (KR) 10-2023-0057038

(51) Int. Cl. B41J 2/045

(52) U.S. Cl. CPC B41J 2/04535; B41J 2/0456; B41J 2/04586

(57) ABSTRACT

An ink droplet volume measurement apparatus including an oblique illumination configured to emit light at a first angle to ink droplets deposited onto a substrate, an imaging device configured to obtain planar images of the ink droplets and a shadow of the ink droplets generated by the emitted light and a calculation device configured to calculate a volume of the ink droplets deposited onto the substrate based on the planar images of the ink droplets and the shadow of the ink droplets.

This application claims priority to Korean Patent Application No. 10-2023-0057038, filed on May 2, 2023, and all the benefits accruing therefrom under 35 U.S.C. § 119, the content of which in its entirety is herein incorporated by reference.

### BACKGROUND

### 1. Field

The invention relates to an ink droplet volume measurement apparatus, an inkjet printing apparatus including the same, and a method of measuring an ink droplet volume.

### 2. Description of the Related Art

An inkjet printing device may be used in a manufacturing process of an electronic device. For example, in manufacturing a display device such as an emissive display device or a liquid crystal display, patterns such as a color filter layer, a color conversion layer, and an emission layer may be formed using an inkjet printing apparatus.

In order to manage print quality of such an inkjet printing apparatus, it is necessary to measure an ink ejection amount. The ink ejection amount may be managed by measuring a volume of ejected ink droplets. A chromatic aberration method that optically measures the volume of droplets ejected on a substrate by an ink droplet volume measurement method, a 2D-image area measurement method for measuring an area of a planar image of droplets that has been deposited on a substrate, and a 2D-image illumination reflection method that measures a diameter of droplets and a diameter of light reflection on a substrate, etc. are currently being used.

### SUMMARY

The chromatic aberration method has a problem in that high-speed and large-quantity measurement is difficult due to a long measurement time thereof, and the 2D-image area measurement method is affected by quality of the substrate, so it may be difficult to perform accurate measurement according to contact angle distribution. In addition, the 2D-image illumination reflection method may cause measurement errors due to a shift in a positional relationship between illumination and droplets.

According to embodiments, the volume of the ejected droplets may be more accurately measured by analyzing both the droplets deposited on the substrate and a shadow of the droplets generated on the substrate. In addition, the ink droplet volume may be measured at a high-speed using a line scan camera and/or an area camera.

An embodiment of the invention provides an ink droplet volume measurement apparatus including an oblique illumination configured to irradiate light at a first angle to droplets that are deposited onto a substrate, an imaging device configured to obtain planar images of the droplets and a shadow of the droplets generated by the oblique illumination and a calculation device configured to calculate the volume of the droplets deposited on the substrate based on the planar images obtained by the imaging device.

In an embodiment, the calculation device may calculate a height h of the droplets using Equation 1 below:

$$[ Equation 1 ]$$

$$h = \frac{2 A \times tan ( α ) \times cos ( α ) + \sqrt{{( 2 A \times tan ( α ) \times cos ( α ) )}^{2} + 4 {B}^{2} \times ( 3 \times {cos ( α )}^{2} + 2 \times cos ( α ) )}}{6 \times cos ( α ) - 2} ,$$

wherein, in Equation 1, A indicates a length of the shadow of the droplets on the planar image, B indicates a radius of the droplets on the planar image, and a indicates a first angle that is formed by light emitted from the oblique illumination and a surface of the substrate.

In an embodiment, the calculation device may set a virtual circle drawn by extending the cross-section of the droplets deposited onto the substrate, and may calculate the radius r of the virtual circle using Equation 2 below:

$$r = \frac{{B}^{2} + {h}^{2}}{2 h} , \qquad [ Equation 2 ]$$

wherein, in Equation 2, B indicates the radius of the droplets in the planar image, and h indicates the height h of the droplets deposited onto the substrate.

In an embodiment, the calculation device may calculate a contact angle θ of the droplets deposited onto the substrate with the substrate using Equation 3 below:

$$θ = 2 arctan \frac{h}{r} , \qquad [ Equation 3 ]$$

wherein, in Equation 3, r indicates the radius of the virtual circle, and h indicates the height of the droplets deposited onto the substrate.

In an embodiment, the calculation device may calculate a volume V of the droplets deposited onto the substrate using Equation 4 below:

$$V = \frac{π {h}^{2}}{3} ( 3 r - h ) , \qquad [ Equation 4 ]$$

wherein, in Equation 4, r indicates the radius of the virtual circle, and h indicates the height of the droplets deposited onto the substrate.

In an embodiment, the calculation device may calculate the volume V of the droplets deposited onto the substrate using Equation 5 below:

$$V = \frac{1}{6} π h ( 3 {B}^{2} - {h}^{2} ) , \qquad [ Equation 5 ]$$

wherein, in Equation 5, B indicates the radius of the deposited droplets, and h indicates the height of the droplets deposited onto the substrate.

In an embodiment, the first angle of light emitted from the oblique illumination may be greater than about 0 degrees and smaller than about 90 degrees.

In an embodiment, the imaging device may include at least one of an area camera that captures an image of a predetermined unit area or a line scan camera that captures an image in a predetermined line unit.

An embodiment of the invention provides an inkjet printing apparatus including an inkjet head configured to include nozzles for ejecting ink droplets onto a substrate, a controller configured to control the ink droplets to be ejected through the nozzles and a measurement device configured to measure a volume of the ejected ink droplets, wherein the measurement device may include an oblique illumination configured to irradiate light at a first angle to the droplets deposited onto the substrate and an imaging device configured to obtain planar images of the droplets and a shadow of the droplets generated by the oblique illumination.

In an embodiment, the controller may calculate the height h of the droplets using Equation 1 below:

$$[ Equation 1 ]$$

$$h = \frac{2 A \times tan ( α ) \times cos ( α ) + \sqrt{{( 2 A \times tan ( α ) \times cos ( α ) )}^{2} + 4 {B}^{2} \times ( 3 \times {cos ( α )}^{2} + 2 \times cos ( a ) )}}{6 \times cos ( α ) - 2} ,$$

wherein, in Equation 1, A indicates a length of the shadow of the droplets on the planar image, B indicates the radius of the droplets on the planar image, and a indicates the first angle formed by light emitted from the oblique illumination and the surface of the substrate.

In an embodiment, the controller may set a virtual circle drawn by extending a cross-section of the droplets deposited onto the substrate, and may calculate the radius r of the virtual circle using Equation 2 below:

$$r = \frac{{B}^{2} + {h}^{2}}{2 h} , \qquad [ Equation 2 ]$$

wherein, in Equation 2, B indicates the radius of the droplets in the planar image, and h indicates the height of the droplets deposited onto the substrate.

In an embodiment, the controller may calculate the contact angle θ of the droplets deposited onto the substrate with the substrate using Equation 3 below:

$$θ = 2 arc tan \frac{h}{r} , \qquad [ Equation 3 ]$$

wherein, in Equation 3, r indicates the radius of the virtual circle, and h indicates the height of the droplets deposited onto the substrate.

In an embodiment, the controller may calculate the volume V of the droplets deposited onto the substrate using Equation 4 below:

$$V = \frac{π {h}^{2}}{3} ( 3 r - h ) , \qquad [ Equation 4 ]$$

wherein, in Equation 4, r indicates a radius of the virtual circle, and h indicates a height of the droplets deposited onto the substrate.

In an embodiment, the controller may calculate the volume V of the droplets deposited onto the substrate using Equation 5 below:

$$V = \frac{1}{6} π h ( 3 {B}^{2} + {h}^{2} ) , \qquad [ Equation 5 ]$$

wherein, in Equation 5, B indicates the radius of the deposited droplets, and h indicates the height of the droplets deposited onto the substrate.

In an embodiment, the invention may further include a calculation device configured to calculate the volume of the droplets deposited onto the substrate based on the planar image obtained by the imaging device.

An embodiment of the invention provides an ink droplet volume measurement method for measuring a volume of ink droplets deposited onto a substrate, wherein the method includes radiating oblique light to the droplets at a first angle, acquiring planar images of the droplets and a shadow of the droplets, measuring a radius of the droplets and a length of the shadow from the planar images and deriving a volume of the droplets based on the radius of the droplets, the length of the shadow, and the first angle.

In an embodiment, the deriving of the volume of the droplets may include calculating the height h of the droplets using Equation 1 below:

$$[ Equation 1 ]$$

$$h = \frac{2 A \times tan ( α ) \times cos ( α ) + \sqrt{{( 2 A \times tan ( α ) \times cos ( α ) )}^{2} + 4 {B}^{2} \times ( 3 \times {cos ( α )}^{2} + 2 \times cos ( a ) )}}{6 \times cos ( α ) - 2} ,$$

wherein, in Equation 1, A indicates the length of the shadow of the droplets on the planar image, B indicates the radius of the droplets on the planar image, and a indicates the first angle formed by light emitted from the oblique illumination and the surface of the substrate.

In an embodiment, the deriving of the volume of the droplets may further include setting a virtual circle drawn by extending a cross-section of the droplets deposited onto the substrate, and calculating the radius r of the virtual circle using Equation 2 below:

$$r = \frac{{B}^{2} + {h}^{2}}{2 h} , \qquad [ Equation 2 ]$$

wherein, in Equation 2, B indicates the radius of the droplets in the planar image, and h indicates the height of the droplets deposited onto the substrate.

In an embodiment, the deriving of the volume of the droplets may further include calculating the contact angle θ of the droplets deposited onto the substrate with the substrate using Equation 3 below:

$$θ = 2 arc tan \frac{h}{r} , \qquad [ Equation 3 ]$$

wherein, in Equation 3, r indicates the radius of the virtual circle, and h indicates the height of the droplets deposited onto the substrate.

In an embodiment, the deriving of the volume of the droplets may further include calculating the volume V of the droplets deposited onto the substrate using Equation 4 or Equation 5 below:

$$V = \frac{π {h}^{2}}{3} ( 3 r - h ) , \qquad [ Equation 4 ]$$

wherein, in Equation 4, r indicates the radius of the virtual circle, and h indicates the height of the droplets deposited onto the substrate, and

$$V = \frac{1}{6} π h ( 3 {B}^{2} + {h}^{2} ) , \qquad [ Equation 5 ]$$

wherein, in Equation 5, B indicates the radius of the deposited droplets, and h indicates the height of the droplets deposited onto the substrate.

According to embodiments, the volume of the droplets ejected from the inkjet printing apparatus may be more accurately measured, and the volume of the droplets may be measured at a high speed. Accordingly, stable quality and high productivity may be guaranteed.

### BRIEF DESCRIPTION OF THE DRAWINGS

FIG. 1 illustrates a schematic diagram of an inkjet printing apparatus, according to an embodiment.

FIG. 2 illustrates a block diagram of an ink droplet volume measurement device, according to an embodiment.

FIG. 3 illustrates a schematic diagram of an ink droplet volume measurement apparatus, according to an embodiment.

FIG. 4 illustrates a flowchart illustrating an ink droplet measurement method, according to an embodiment.

FIG. 5 illustrates a top plan view of an ink droplet and an ink droplet shadow for describing an ink droplet measurement method, according to an embodiment.

FIG. 6 illustrates a cross-sectional view of an ink droplet on a substrate for describing an ink droplet measurement method, according to an embodiment.

### DETAILED DESCRIPTION

The present invention will be described more fully hereinafter with reference to the accompanying drawings, in which embodiments of the disclosure are shown. The disclosed embodiments may be modified in various different ways, all without departing from the spirit or scope of the invention.

To clearly describe the present invention, parts that are irrelevant to the description are omitted, and like reference numerals refer to like or similar elements throughout the specification. Within the Figures and the text of the disclosure, a reference number indicating a singular form of an element may also be used to reference a plurality of the singular element.

Further, since sizes and thicknesses of members shown in the accompanying drawings are arbitrarily given for better understanding and ease of description, the present invention is not limited to the illustrated sizes and thicknesses. In the drawings, the thicknesses of layers, films, panels, regions, etc., are exaggerated for clarity. In the drawings, for better understanding and ease of description, the thicknesses of some layers and areas are exaggerated.

It should be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” may mean positioned on or below the object portion, and does not necessarily mean positioned on the upper side of the object portion based on a gravitational direction.

Further, unless explicitly described to the contrary, the word “comprise” and variations such as “comprises” or “comprising” should be understood to imply the inclusion of stated elements but not the exclusion of any other elements.

Further, throughout the specification, the phrase “in a plan view” means when an object portion is viewed from above, and the phrase “in a cross-sectional view” means when a cross-section taken by vertically cutting an object portion is viewed from the side.

In the drawings, signs “X,” “Y,” and “Z” are used to indicate directions, wherein X is used for indicating a first direction, Y is used for indicating a second direction that is perpendicular to the first direction, and Z is used for indicating a third direction that is perpendicular to the first direction and the second direction. In addition, to overlap two elements means that two elements are overlapped in the third direction Z (e.g., a direction perpendicular to an upper surface of the substrate) unless stated otherwise.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

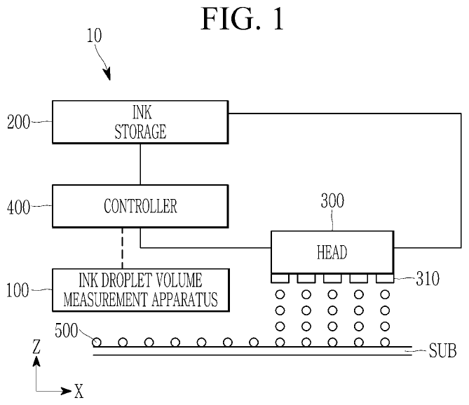

FIG. 1 illustrates a schematic diagram of an inkjet printing apparatus, according to an embodiment.

In an embodiment and referring to FIG. 1, the inkjet printing apparatus 10 may include an ink storage 200, an inkjet head 300, a nozzle portion 310, a controller 400, and an ink droplet volume measurement apparatus 100.

In an embodiment, the ink storage 200 may store ink used in the inkjet printing apparatus 10. The ink storage 200 may supply the stored ink to the inkjet head 300. The ink storage 200 may be provided separately from the inkjet head 300, and/or may be provided integrally with the inkjet head 300.

In an embodiment, the inkjet head 300 may be connected to the ink storage 200, and may eject ink supplied from the ink storage 200 through the nozzle portion 310 at a predetermined speed and quantity.

In an embodiment, the nozzle portion 310 may be positioned at a lower portion of the inkjet head 300. The nozzle portion 310 may include a plurality of nozzles. The nozzle portion 310 may protrude downward from the inkjet head 300, or may be provided in the form of a hole or an opening on a lower surface of the inkjet head 300. Ink droplets 500 may be dripped onto a substrate SUB through the nozzle portion 310. A number, a distance, and/or a size of the nozzle portions 310 may be variously changed.

In an embodiment, the controller 400 may be connected to each component of the inkjet printing apparatus 10 to control overall operations of the inkjet printing apparatus 10. For example, the controller 400 may be electrically connected to the inkjet head 300. The controller 400 may control the inkjet head 300 to eject ink. The controller 400 may control movement of the inkjet head 300. The controller 400 may include a plurality of modules providing a plurality of functions, or may be provided as a single module.

In an embodiment, the ink droplet volume measurement apparatus 100 is for measuring an ejection number of droplets that are ejected through the nozzle portion 310. The ink droplet volume measurement apparatus 100 may be included as a part of the inside of the inkjet printing apparatus 10, or may be provided as a separate apparatus outside the inkjet printing apparatus 10.

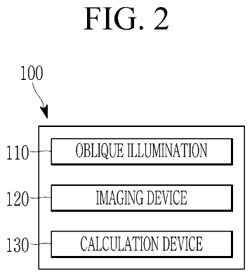

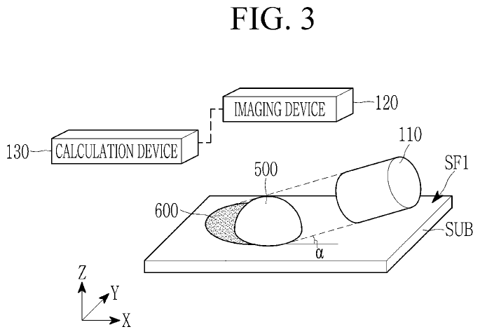

FIG. 2 illustrates a block diagram of an ink droplet volume measurement device, according to one embodiment. FIG. 3 illustrates a schematic diagram of an ink droplet volume measurement apparatus, according to an embodiment.

Referring to FIG. 2 and FIG. 3, the ink droplet volume measurement apparatus 100, according to an embodiment, may include an oblique illumination 110, an imaging device 120, and a calculation device 130.

The oblique illumination 110 may be an oblique light device that radiates light to the substrate SUB at a first inclination angle α. An angle between light emitted from the oblique illumination 110 and a surface of the substrate SUB may be defined as the first inclination angle α. The first inclination angle α may be an acute angle that is greater than about 0 degrees and smaller than about 90 degrees. Since the oblique illumination 110 emits light to form the first inclination angle α with an upper surface SF1 of the substrate SUB, a shadow of the ink droplets 500 may be created at an opposite side of the oblique illumination 110.

In an embodiment, the imaging device 120 may acquire planar images of the ink droplets 500 that have been deposited onto the substrate SUB and a shadow 600 of the ink droplets 500. The imaging device 120 may be positioned above the ink droplets 500 to capture planar images of the ink droplets 500 and the shadow 600. The imaging device 120 may include, for example, an area camera that captures an image of a predetermined unit area and/or a line scan camera that captures an image in a predetermined line unit. The line scan camera may acquire an image in line units using an image sensor having only one line of a plurality of horizontal pixels or vertical pixels. The area camera may acquire an image in area units using an image sensor having a plurality of horizontal pixels and a plurality of vertical pixels.

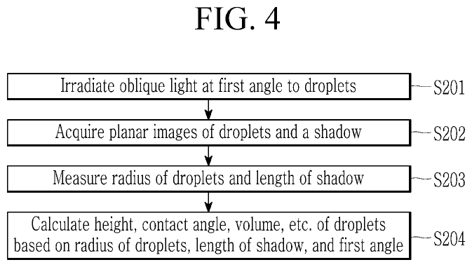

In an embodiment, an image acquired by the imaging device 120 may be transmitted to the calculation device 130. The calculation device 130 may calculate a height, a volume, a contact angle, etc. of the ink droplets 500 using the planar image of the ink droplets 500 that are deposited onto the substrate SUB. The calculation device 130 may be included in the controller 400 of the inkjet printing apparatus 10 or may be configured as a separate module. For example, the calculation device 130 may be a separate component including at least one processor, and/or may be entirely or partially implemented as software or hardware operating on a general-purpose processor, etc. Hereinafter, a specific ink droplet volume measurement method will be described with reference to FIG. 4 to FIG. 6.

FIG. 4 illustrates a flowchart of an ink droplet measurement method, according to an embodiment.

An ink droplet measurement method, according to an embodiment, includes irradiating light at a first angle α to ink droplets 500 that are deposited onto a substrate (S201), acquiring a planar image of the ink droplets 500 and a planar image of a shadow 600 generated by irradiation of the ink droplets 500 by an oblique light (S202), measuring a radius of the ink droplets 500 and a length of the shadow 600 from the obtained planar images (S203), and calculating a height, a contact angle, a volume, etc. of the ink droplets 500 based on the measured radius of the ink droplets 500, the length of the shadow 600, and the first angle α (S204).

According to an embodiment, in step S201, light is irradiated at the first angle α by using the oblique illumination 110 to shine light onto the ink droplets 500 that deposited on a substrate. The first angle α is a first inclination angle α (see FIG. 3) formed by light emitted from the oblique illumination 110 and a surface SF1 of the substrate SUB. According to irradiation of the oblique light, a shadow 600 of the ink droplets 500 deposited onto the substrate SUB may be formed.

In step S202, the planar images of the ink droplets 500 and the shadow 600 may be acquired through the imaging device 120. The imaging device 120 may be positioned above the ink droplets 500 deposited on the substrate SUB, and the planar images of the ink droplets 500 and the shadow 600 may be acquired through the imaging device 120.

Then, the radius of the ink droplets 500 and the length of the shadow 600 may be measured from the planar images acquired in step S203.

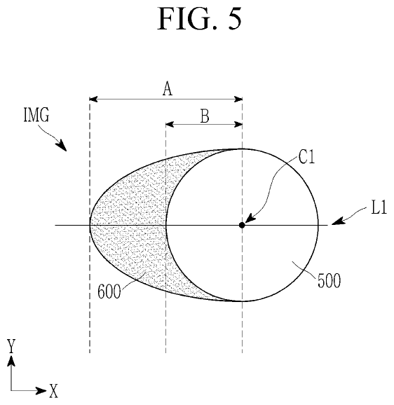

Referring to FIG. 5, planar images IMG of the ink droplets 500 and the shadow 600 obtained, according to an embodiment, may be checked. The planar image of the ink droplets 500 has a circular shape including a center C1, and according to irradiation of the oblique light, the shadow 600 of the ink droplets 500 extends and is positioned at a first side of the ink droplets 500 (opposite side of the oblique light). Along a line L1 extending through the center C1 of the planar image of the ink droplets 500 in a first direction X, a radius B of the ink droplets 500 and a length A of the shadow 600 may be defined.

In an embodiment, in step S204, a height h, a volume V, and a contact angle θ of the ink droplets 500 may be calculated from the first inclination angle α of the oblique illumination 110 and the measured radius B of the ink droplets 500 and the length A of the shadow 600.

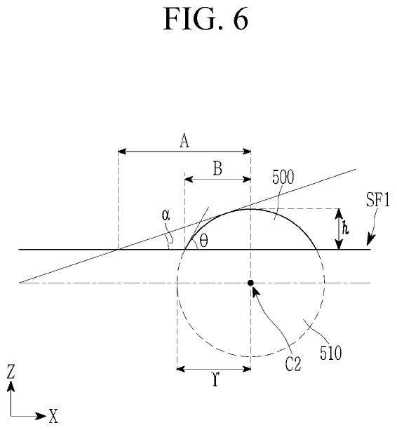

According to an embodiment, FIG. 6 illustrates a virtual circle 510 drawn by extending a cross-section of the ink droplets 500 that are deposited onto an upper surface SF1 of the substrate SUB and a cross-sectional shape of the deposited ink droplets 500. In an embodiment, the deposited ink droplets 500 may have the height h from the upper surface SF1 of the substrate SUB and the contact angle θ with the upper surface SF1 of the substrate SUB. The height h may indicate a distance from the upper surface SF1 of the substrate SUB to a highest part of the ink droplets 500.

In addition, in an embodiment, the virtual circle 510 extending from the deposited ink droplets 500 may include a center C2 and a radius r of the circle.

According to an embodiment, the calculation device 130 (see FIG. 2 and FIG. 3) may calculate the height h, the volume V, and the contact angle θ of the ink droplets 500 from the first inclination angle α of the oblique illumination 110 and the measured radius B of the ink droplets 500 and the length A of the shadow 600. A volume V of the finally deposited ink droplets 500 may be calculated by the following procedure.

First, in an embodiment, the height h of the deposited ink droplets 500 may be derived by applying the first inclination angle α of the oblique light, the radius B of the ink droplets 500 and the length A of the shadow 600 of the obtained planar image to Equation 1 below.

$$[ Equation 1 ]$$

$$h = \frac{2 A \times tan ( α ) \times cos ( α ) + \sqrt{{( 2 A \times tan ( α ) \times cos ( α ) )}^{2} + 4 {B}^{2} \times ( 3 \times {cos ( α )}^{2} + 2 \times cos ( a ) )}}{6 \times cos ( α ) - 2} ,$$

wherein, h indicates the height of the deposited ink droplets, A indicates the length of the shadow 600 of the acquired planar image, B indicates the radius of the ink droplets 500 of the acquired planar image, and a indicates the first angle formed by the oblique illumination 110 with a surface SF1 of the substrate SUB. As such, the height h of the ink droplets 500 deposited onto the substrate SUB may be derived through Equation 1.

Thereafter, in an embodiment, the radius r of the virtual circle 510 drawn by extending the cross-section of the deposited ink droplets 500 may be derived by applying the height h of the deposited ink droplets 500 and the radius B of the planar image of the deposited ink droplets to Equation 2 below.

$$r = \frac{{B}^{2} + {h}^{2}}{2 h} , \qquad [ Equation 2 ]$$

wherein, r indicates the radius of the virtual circle 510, B indicates the radius of the deposited ink droplets 500, and h indicates the height of the deposited ink droplets 500. As such, the radius r of the virtual circle 510 including a partial cross-section of the deposited ink droplets 500 may be derived through Equation 2. The radius r of the virtual circle 510 may then be used to calculate the contact angle θ and the volume V.

Then, in an embodiment, the contact angle θ of the ink droplets 500 may be derived by applying the height h of the ink droplets 500 and the radius r of the virtual circle 510 to Equation 3 below.

$$θ = 2 arc tan \frac{h}{r} , \qquad [ Equation 3 ]$$

wherein, θ indicates the contact angle of deposited ink droplets 500 with the substrate SUB, r indicates the radius of the virtual circle 510, and h indicates the height of the deposited ink droplets 500. As such, the contact angle θ of the deposited ink droplets 500 may be derived through Equation 3.

Meanwhile, in an embodiment, the volume V of the deposited ink droplets 500 may be derived using Equation 4 below.

$$V = \frac{π {h}^{2}}{3} ( 3 r - h ) , \qquad [ Equation 4 ]$$

wherein, V indicates the volume of the deposited ink droplets 500, r indicates the radius of the virtual circle 510, and h indicates the height of the deposited ink droplets 500. As such, the volume V of the deposited ink droplets 500 may be derived through Equation 4.

In addition, in an embodiment, the volume V of the deposited ink droplets 500 may also be derived using Equation 5 below.

$$V = \frac{1}{6} π h ( 3 {B}^{2} + {h}^{2} ) , \qquad [ Equation 5 ]$$

wherein, V indicates the volume of the deposited ink droplets 500, B indicates the radius of the deposited ink droplets 500, and h indicates the height of the deposited ink droplets 500. As such, the volume V of the deposited ink droplets 500 may be derived through Equation 5.

As such, the ink droplet volume measurement apparatus according to an embodiment may derive the height h of the deposited ink droplets 500 from the first angle α of the oblique illumination 110, the measured radius B of the deposited ink droplets 500, the length A of the shadow 600, the radius r of the virtual circle 510 drawn by extending the cross-section of the deposited ink droplets 500 using the height h of the deposited ink droplets 500 and the radius B of the planar image of the deposited ink droplets 500, and may calculate the contact angle θ and the volume V of the ink droplets 500 using the height h of the deposited ink droplets 500 and the radius r of the virtual circle 510.

The ink droplet volume measurement apparatus, according to an embodiment, may measure the first angle of the oblique light, the radius of the deposited ink droplets 500 and the length of the shadow 600 together, and may derive the volume of the ink droplets 500 based on these relations, thereby preventing measurement errors due to a positional relationship between the oblique light and the ink droplets 500, and preventing an influence of quality of a substrate surface or distribution of the contact angle.

In addition, in an embodiment, images may be taken at a high speed using a line scan camera, and an image of a large area may be captured using an area camera, and thus it is advantageous for measuring a large amount of ink droplet volume at high speed.

While the invention has been described in connection with what is presently considered to be practical embodiments, it should be understood that the invention is not limited to the disclosed embodiments, but, on the contrary, is intended to cover various modifications and equivalent arrangements included within the spirit and scope of the appended claims. Moreover, the embodiments or parts of the embodiments may be combined in whole or in part without departing from the scope of the invention.

What is claimed is:

1. An ink droplet volume measurement apparatus comprising:
an oblique illumination configured to emit light at a first angle to droplets deposited onto a substrate;
an imaging device configured to obtain a planar image of the droplets deposited onto the substrate and a shadow of the droplets deposited onto the substrate generated by the light; and
a calculation device configured to calculate a volume of the droplets deposited onto the substrate based on droplets in the planar image and shadow in the planar image obtained by the imaging device.

2. The ink droplet volume measurement apparatus of claim 1, wherein
the calculation device calculates a height h of the droplets deposited onto the substrate, wherein the height h of the droplets deposited onto the substrate is given by: [symbol]
wherein, A indicates a length of the shadow of the droplets in the planar image, B indicates a radius of the droplets in the planar image, and a indicates a first angle formed between the light and a surface of the substrate.

3. The ink droplet volume measurement apparatus of claim 2, wherein
the calculation device generates a virtual circle by extending a cross-section of the droplets deposited onto the substrate, and
calculates a radius r of the virtual circle, wherein the radius r of the virtual circle is given by: [symbol]
wherein, B indicates a radius of the droplets in the planar image, and h indicates a height of the droplets deposited onto the substrate.

4. The ink droplet volume measurement apparatus of claim 3, wherein
the calculation device calculates a contact angle θ between the droplets deposited onto the substrate and the substrate, wherein the contact angle θ is given by: [symbol]
wherein, r indicates a radius of the virtual circle, and h indicates a height of the droplets deposited onto the substrate.

5. The ink droplet volume measurement apparatus of claim 4, wherein
the calculation device calculates a volume V of the droplets deposited onto the substrate, wherein the volume V is given by: [symbol]
wherein, r indicates a radius of the virtual circle, and h indicates a height of the droplets deposited onto the substrate.

6. The ink droplet volume measurement apparatus of claim 4, wherein
the calculation device calculates a volume V of the droplets deposited onto the substrate, wherein the volume V is given by: [symbol]
wherein, B indicates a radius of the droplets deposited onto the substrate, and h indicates a height of the droplets deposited onto the substrate.

7. The ink droplet volume measurement apparatus of claim 1, wherein
the first angle is greater than about 0 degrees and smaller than about 90 degrees.

8. The ink droplet volume measurement apparatus of claim 1, wherein
the imaging device includes at least one of an area camera that captures an image of a predetermined unit area or a line scan camera that captures an image in a predetermined line unit.

9. An inkjet printing apparatus comprising:
an inkjet head configured to include nozzles for ejecting ink droplets onto a substrate;
a controller configured to control the ink jet head to control the ink droplets ejected through the nozzles; and
a measurement device configured to measure a volume of the ink droplets ejected through the nozzles;
wherein the measurement device includes:
an oblique illumination configured to emit light at a first angle to the ink droplets deposited onto the substrate to generate a shadow of the ink droplets; and
an imaging device configured to obtain a planar image of the ink droplets and the shadow of the ink droplets.

10. The inkjet printing apparatus of claim 9, wherein
the controller calculates a height h of the droplets, wherein the height h is given by: [symbol]
wherein, A indicates a length of the shadow of the ink droplets in the planar image, B indicates a radius of the ink droplets in the planar image, and a indicates a first angle formed between the light emitted from the oblique illumination and a surface of the substrate.

11. The inkjet printing apparatus of claim 10, wherein
the controller generates a virtual circle drawn by extending a cross-section of the ink droplets deposited onto the substrate, and
calculates a radius r of the virtual circle, wherein the radius r of the virtual circle is given by: [symbol]
wherein, B indicates a radius of the ink droplets in the planar image, and h indicates a height of the ink droplets deposited onto the substrate.

12. The inkjet printing apparatus of claim 11, wherein
the controller calculates a contact angle θ between the droplets deposited onto the substrate and the substrate, wherein the contact angle θ is given by: [symbol]
wherein, r indicates a radius of the virtual circle, and h indicates a height of the ink droplets deposited onto the substrate.

13. The inkjet printing apparatus of claim 12, wherein
the controller calculates a volume V of the ink droplets deposited onto the substrate, wherein the volume V is given by: [symbol]
wherein, r indicates a radius of the virtual circle, and h indicates a height of the ink droplets deposited onto the substrate.

14. The inkjet printing apparatus of claim 12, wherein
the controller calculates a volume V of the ink droplets deposited onto the substrate, wherein the volume V is given by: [symbol]
wherein, in B indicates a radius of the ink droplets deposited onto the substrate, and h indicates a height of the ink droplets deposited onto the substrate.

15. The inkjet printing apparatus of claim 9, wherein
a calculation device is configured to calculate a volume of the ink droplets deposited onto the substrate based on the planar image of the ink droplets and the shadow of the ink droplets obtained by the imaging device.

16. An ink droplet volume measurement method for measuring a volume of ink droplets deposited onto a substrate, the method comprising:
emitting oblique light to the ink droplets at a first angle;
acquiring planar images of the ink droplets and a shadow of the ink droplets;
measuring a radius of the ink droplets and a length of the shadow of the ink droplets from the planar images; and
deriving a volume of the ink droplets based on the radius of the ink droplets, the length of the shadow of the ink droplets, and the first angle.

17. The ink droplet volume measurement method of claim 16, wherein
the deriving a volume of the ink droplets includes
calculating a height h of the ink droplets, wherein the height h of the ink droplets is given by: [symbol]
wherein, A indicates a length of the shadow of the ink droplets in the planar image, B indicates a radius of the ink droplets in the planar image, and a indicates a first angle formed between light emitted from the oblique illumination and a surface of the substrate.

18. The ink droplet volume measurement method of claim 17, wherein
the deriving a volume of the ink droplets
further includes generating a virtual circle drawn by extending a cross-section of the ink droplets deposited onto the substrate, and
calculating a radius r of the virtual circle, wherein the radius r is given by: [symbol]
wherein, B indicates a radius of the ink droplets in the planar image, and h indicates a height of the ink droplets deposited onto the substrate.

19. The ink droplet volume measurement method of claim 18, wherein
the deriving a volume of the ink droplets
further includes calculating a contact angle θ between the ink droplets deposited onto the substrate and the substrate, wherein the contact angle θ is given by: [symbol]
wherein, r indicates a radius of the virtual circle, and h indicates a height of the ink droplets deposited onto the substrate.

20. The ink droplet volume measurement method of claim 19, wherein
the deriving a volume of the ink droplets
further includes calculating a volume V of the ink droplets deposited onto the substrate, wherein the volume V is given by one of: [symbol]
wherein, r indicates a radius of the virtual circle, and h indicates a height of the ink droplets deposited onto the substrate, or [symbol]
wherein, B indicates a radius of the ink droplets deposited onto the substrate, and h indicates a height of the ink droplets deposited onto the substrate.
